(19) United States
(12) Patent Application Publication
(10) Pub. No.: US 2023/0291514 A1
(43) Pub. Date: Sep. 14, 2023

(54) DETERMINING TRANSMISSIONS TO AVOID

(71) Applicant: Lenovo (Singapore) PTE. LTD., New Tech Park (SG)

(72) Inventors: Karthikeyan Ganesan, Kronberg im Taunus (DE); Prateek Basu Mallick, Dreieich (DE); Joachim Loehr, Wiesbaden (DE); Ravi Kuchibhotla, Chicago, IL (US)

(21) Appl. No.: 17/999,174

(22) PCT Filed: May 17, 2021
(86) PCT No.: PCT/IB2021/054226

§ 371 Date: Nov. 17, 2022

Related U.S. Application Data
(60) Provisional application No. 63/026,403, filed on May 18, 2020.
(60) Provisional application No. 63/026,425, filed on May 18, 2020.

(51) Int. Cl. H04L 5/00; H04W 72/02; H04W 72/563

(52) U.S. Cl. CPC H04L 5/0037; H04L 5/0053; H04L 5/0094; H04W 72/02; H04W 72/563

(57) ABSTRACT

Apparatuses, methods, and systems are disclosed for determining transmissions to avoid. One method includes receiving, at a first user equipment, information from a second user equipment indicating second resources used by the second user equipment for a second transmission to a third user equipment. The method includes determining whether the second resources used by the second user equipment for the second transmission to the third user equipment overlap with first resources used by the first user equipment for a first transmission to the third user equipment. The method includes, in response to determining that the second resources overlap with the first resources, determining whether to avoid the first transmission on the first resources based on a destination identifier, a logical channel prioritization procedure, or a combination thereof.

### CROSS-REFERENCE TO RELATED APPLICATIONS

This application claims priority to U.S. Pat. Application Serial No. 63/026,403 entitled “APPARATUSES, METHODS, AND SYSTEMS FOR SL RESOURCE SELECTION ENHANCEMENT TO AVOID CONSECUTIVE PACKET LOSS” and filed on May 18, 2020 for Karthikeyan Ganesan and U.S. Pat. Application Serial No. 63/026,425 entitled “APPARATUSES, METHODS, AND SYSTEMS FOR RECEIVER ASSISTANCE TO AVOID CONSECUTIVE ERRORS IN SIDELINK” and filed on May 18, 2020 for Karthikeyan Ganesan, all of which are incorporated herein by reference in their entirety.

### FIELD

The subject matter disclosed herein relates generally to wireless communications and more particularly relates to determining transmissions to avoid.

### BACKGROUND

In certain wireless communications networks, half duplex transmissions may be used. Such transmissions may overlap and/or interfere with one another.

### BRIEF SUMMARY

Methods for determining transmissions to avoid are disclosed. Apparatuses and systems also perform the functions of the methods. One embodiment of a method includes receiving, at a first user equipment, information from a second user equipment indicating second resources used by the second user equipment for a second transmission to a third user equipment. In some embodiments, the method includes determining whether the second resources used by the second user equipment for the second transmission to the third user equipment overlap with first resources used by the first user equipment for a first transmission to the third user equipment. In certain embodiments, the method includes, in response to determining that the second resources overlap with the first resources, determining whether to avoid the first transmission on the first resources based on a destination identifier, a logical channel prioritization procedure, or a combination thereof.

One apparatus for determining transmissions to avoid includes a receiver that receives information from a second user equipment indicating second resources used by the second user equipment for a second transmission to a third user equipment. In various embodiments, the apparatus includes a processor that: determines whether the second resources used by the second user equipment for the second transmission to the third user equipment overlap with first resources used by the first user equipment for a first transmission to the third user equipment; and, in response to determining that the second resources overlap with the first resources, determines whether to avoid the first transmission on the first resources based on a destination identifier, a logical channel prioritization procedure, or a combination thereof.

An embodiment of a method for triggering a change includes receiving, at a first user equipment, triggering information that triggers change in a resource allocation procedure mode or a change in communication protocol. In some embodiments, the method includes, in response to receiving the triggering information, changing the resource allocation procedure mode or changing the communication protocol.

An apparatus for triggering a change includes a receiver that receives triggering information that triggers change in a resource allocation procedure mode or a change in communication protocol. In various embodiments, the apparatus includes a processor that, in response to receiving the triggering information, changes the resource allocation procedure mode or changing the communication protocol.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining transmissions to avoid;

FIG. 2 is a schematic block diagram illustrating one embodiment of an apparatus that may be used for determining transmissions to avoid;

FIG. 3 is a schematic block diagram illustrating one embodiment of an apparatus that may be used for determining transmissions to avoid;

FIG. 4 is a timing diagram illustrating one embodiment of a half-duplex transmission interference;

FIG. 5 is a schematic block diagram illustrating one embodiment of communications between user equipments;

FIG. 6 is a flow chart diagram illustrating one embodiment of a method for determining transmissions to avoid; and

FIG. 7 is a flow chart diagram illustrating one embodiment of a method for triggering a change.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (anon-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

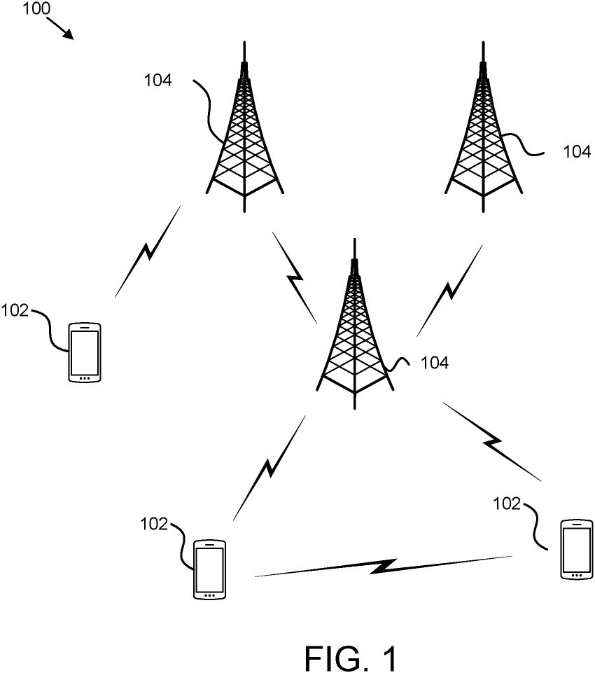

FIG. 1 depicts an embodiment of a wireless communication system 100 for determining transmissions to avoid. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a first user equipment, information from a second user equipment indicating second resources used by the second user equipment for a second transmission to a third user equipment. In some embodiments, the remote unit 102 may determine whether the second resources used by the second user equipment for the second transmission to the third user equipment overlap with first resources used by the first user equipment for a first transmission to the third user equipment. In certain embodiments, the remote unit 102 may, in response to determining that the second resources overlap with the first resources, determine whether to avoid the first transmission on the first resources based on a destination identifier, a logical channel prioritization procedure, or a combination thereof. Accordingly, the remote unit 102 may be used for determining transmissions to avoid.

In certain embodiments, a remote unit 102 may receive, at a first user equipment, triggering information that triggers change in a resource allocation procedure mode or a change in communication protocol. In some embodiments, the remote unit 102 may, in response to receiving the triggering information, changing the resource allocation procedure mode or changing the communication protocol. Accordingly, the remote unit 102 may be used for triggering a change.

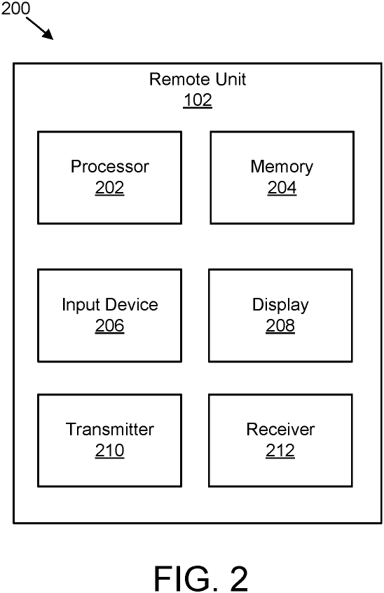

FIG. 2 depicts one embodiment of an apparatus 200 that may be used for determining transmissions to avoid. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In some embodiments, the receiver 212 may receive information from a second user equipment indicating second resources used by the second user equipment for a second transmission to a third user equipment. In various embodiments, the processor 202 may: determine whether the second resources used by the second user equipment for the second transmission to the third user equipment overlap with first resources used by the first user equipment for a first transmission to the third user equipment; and, in response to determining that the second resources overlap with the first resources, determine whether to avoid the first transmission on the first resources based on a destination identifier, a logical channel prioritization procedure, a resource conflict due to half duplex, and/or hidden node, or a combination thereof.

In certain embodiments, the receiver 212 may receive triggering information that triggers change in a resource allocation procedure mode or a change in communication protocol. In various embodiments, the processor 202 may, in response to receiving the triggering information, change the resource allocation procedure mode or changing the communication protocol.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

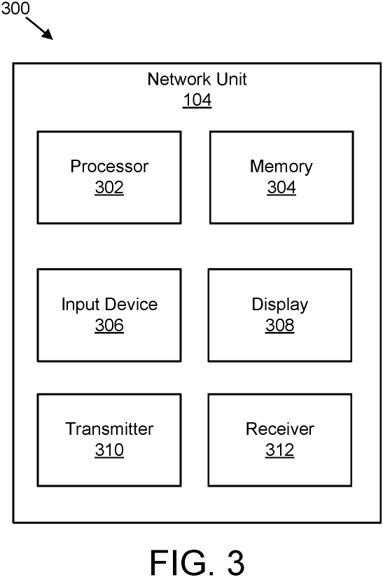

FIG. 3 depicts one embodiment of an apparatus 300 that may be used for determining transmissions to avoid. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, sidelink resource selection enhancement for mode 2 may be made by analyzing various factors associated with consecutive packet loss. The factors associated with consecutive packet loss may include: 1) half duplex transmissions where a first user equipment (“UE”) (UEA) and a second UE (UEB) transmit in the same time slot and cannot hear each other’s transmissions; 2) consecutive negative acknowledgements (“NACKs”) and/or discontinuous transmission (“DTX”) reception from receiver (“RX”) UEs; 3) congestion in a resource pool; and/or 4) interference at a receiver side due to a hidden node.

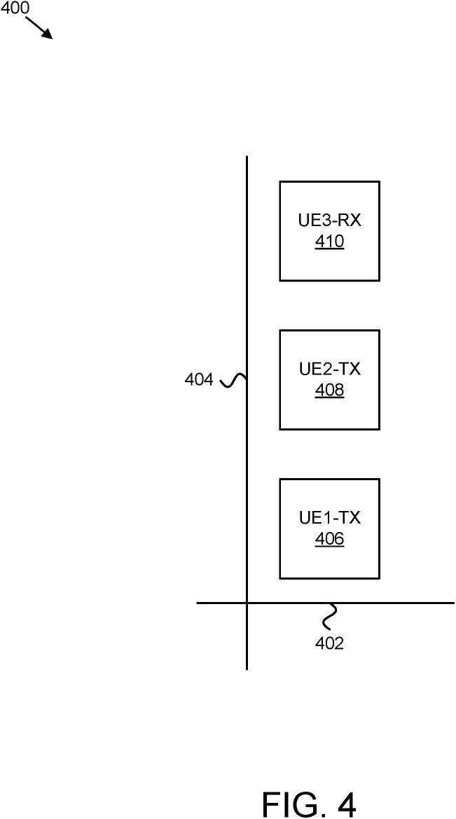

FIG. 4 is a timing diagram 400 illustrating one embodiment of a half-duplex transmission interference. The timing diagram 400 is illustrated over a time 402 and a frequency 404. Moreover, timing of communications between a first transmitter UE 406 (UE1-TX), a second transmitter UE 408 (UE2-TX), and a receiver UE 410 (UE3-RX) are illustrated. With transmissions from the first transmitter UE 406 to the receiver UE 410 being made at the same time as transmissions from the second transmitter UE 408 to the receiver UE 410, the receiver UE 410 receive both transmissions at the same time and they interfere with one another, but the first transmitter UE 406 and the second transmitter UE 408 may not be aware of the interference because they are half-duplex devices that cannot receive data at the same time they are transmitting data.

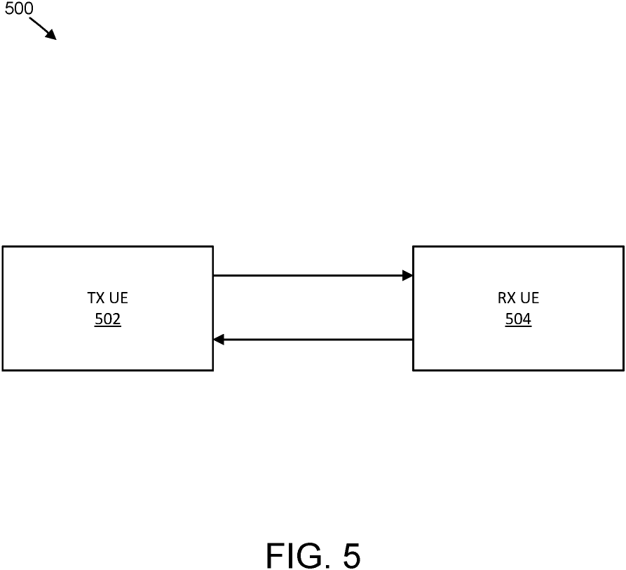

FIG. 5 is a schematic block diagram 500 illustrating one embodiment of communications between user equipments. The diagram 500 includes a transmitter (“TX”) UE 502 and an RX UE 504. The TX UE 502 may transmit information to the RX UE 504 indicating a source identifier (“ID”) of the TX UE 502 and a destination ID for one or more transmissions to be made by the TX UE 502 on one or more resources (e.g., destination ID configured from a higher layer in the TX UE 502). Moreover, the RX UE 504 may transmit information to the TX UE 502 indicating a source ID of the RX UE 504 and a destination ID for one or more transmissions to be made by the RX UE 504 on one or more resources (e.g., destination ID configured from a higher layer in the RX UE 504).

As used herein, embodiments may be described in relation to a destination ID. However, it should be noted that a TX UE may alternately use a source ID (e.g., layer 1 (“L1”) and/or layer 2 (“L2”)) of an RX UE, a destination ID, and/or a destination group ID (e.g., L1 and/or L2). As may be appreciated, the usage of a destination ID (e.g., L1 and/or L2) and a source ID (e.g., L1 and/or L2) may refer to the same RX UE.

In a first embodiment, for a mode 2 (e.g., UE autonomous resource allocation mode) resource exclusion, resource revaluation may take into consideration a problem with half duplex transmissions to a destination.

In the first embodiment, a TX UE may avoid half duplex problems by excluding all frequency resources in a time resource during initial resource selection procedure with sensing results indicating an overlap in the time resource (e.g., by decoding sidelink control information SCI from other UEs).

In a first option of the first embodiment, a higher layer at a time of initial resource selection (or reselection) trigger may provide destination IDs along with other parameters (e.g., priority of a transport block (“TB”), a T2 min, a packet delay budget (“PDB”), and so forth) to a physical (“PHY”) layer for which candidate resource selection and resource exclusion procedures are to be performed. In certain embodiments, a TX UE avoids half duplex transmissions to destination IDs by excluding its own transmission time resource if other UEs have overlapping transmission time resources for transmissions to the same destination ID.

In some embodiments, a PHY layer provides a MAC layer with different sets of candidate resources that show resources not to be used (e.g., set A: not for destination ID X, set B: not for destination ID Y, and so forth).

In various embodiments of the first option, half duplex avoidance may be configured only for high priority traffic and may be configured per logical channel (“LCH”). In certain embodiments of the first option, half duplex avoidance may be needed if a priority-TX of a TX UE transmission is a lower priority than a priority-RX of one or more other UEs (e.g., absolute priority of TX > priority of RX from other UEs). In some embodiments of the first option, a sidelink (“SL”) priority threshold is defined and, if the priority of a TB is above the SL priority threshold, then half duplex avoidance may be performed. In various embodiments of the first option, half duplex avoidance is needed if a SL reference signal received power (“RSRP”) and/or a received signal strength indication (“RSSI”) threshold of RX UEs is above a certain configured threshold. In some embodiments of the first option, half duplex avoidance may be used based on a remaining PDB. In various embodiments of the first option, half duplex avoidance may be used based on a combination of priority and RSRP.

In a second option of the first embodiment, if a new TB is to be transmitted in a configured grant (“CG”) resource or in a reserved resource in a time occasion, a TX UE performs a logical channel prioritization (“LCP”) procedure and excludes destination IDs for the time occasion that have a source L2 ID that has already made reservations in the time occasion.

In various embodiments of the second option, half duplex avoidance may be configured only for high priority traffic and may be configured per logical channel (“LCH”). In certain embodiments of the second option, half duplex avoidance may be needed if a priority-TX of a TX UE transmission is a lower priority than a priority-RX of one or more other UEs (e.g., absolute priority of TX > priority of RX from other UEs). In some embodiments of the second option, a sidelink (“SL”) priority threshold is defined and, if the priority of a TB is above the SL priority threshold, then half duplex avoidance may be performed. In various embodiments of the second option, half duplex avoidance is needed if a SL reference signal received power (“RSRP”) and/or a received signal strength indication (“RSSI”) threshold of RX UEs is above a certain configured threshold. In some embodiments of the second option, half duplex avoidance may be used based on a remaining PDB. In various embodiments of the first option, half duplex avoidance may be used based on a combination of priority and RSRP.

In a third option of the first embodiment, a combination of using the first option and the second option may be used. In the third option, both LCP and candidate resource exclusion processes may be used to avoid half duplex interference problems for transmitting to a destination.

In the first embodiment, a TX UE may perform evaluation (e.g., reevaluation) on selected (e.g., preselected) resources before or at a certain time (e.g., m-T₃) for destination IDs. If received sidelink control information (“SCI”) from other UEs overlaps in a time resource having the same destination ID with that of the selected resources due to half duplex, the TX UE triggers resource reselection if none of the resource from an identified candidate resource set may be used for transmission to that destination ID.

In various embodiments of the first embodiment, half duplex avoidance may be configured only for high priority traffic and may be configured per logical channel (“LCH”). In certain embodiments of the first embodiment, half duplex avoidance may be needed if a priority-TX of a TX UE transmission is a lower priority than a priority-RX of one or more other UEs (e.g., absolute priority of TX > priority of RX from other UEs). In some embodiments of the first embodiment, a sidelink (“SL”) priority threshold is defined and, if the priority of a TB is above the SL priority threshold, then half duplex avoidance may be performed. In various embodiments of the first embodiment, half duplex avoidance is needed if a SL reference signal received power (“RSRP”) and/or a received signal strength indication (“RSSI”) threshold of RX UEs is above a certain configured threshold. In some embodiments of the first embodiment, half duplex avoidance may be used based on a remaining PDB. In various embodiments of the first embodiment, half duplex avoidance may be used based on a combination of priority and RSRP.

In various embodiments, if SCI is received after m-T₃, and it overlaps in a time resource with that of a first destination ID of a selected resource, a TX UE does not transmit if a priority of the selected resource is less than a corresponding priority of other UEs, or the TX UE may transmit in the selected resource a second TB having a second destination ID that does not have any overlap with the first destination ID.

In certain embodiments, a TX UE performs reselection of a resource if SCI received from other UEs indicates an overlap in transmissions to the same destination ID in a time resource.

In some embodiments, a TX UE may transmit a second TB belonging to a different destination ID in a reserved resource after performing a LCP.

In various embodiments, a TX UE avoids half duplex interference only if more than one consecutive transmission is overlaps for the same destination ID and/or if one or more NACKs and/or DTX are received.

In a second embodiment, for mode 1, a TX UE LCP procedure may include a source ID and/or a destination ID to avoid half duplex problems. In such an embodiment, for mode 1, if a SL grant is received from a gNB, the TX UE selects a highest priority logical channel and destination IDs based on the LCP procedure. While performing the LCH and destination IDs selection, the TX UE excludes source IDs of a receiver or destination IDs for transmission in time resources and/or slots indicated in a SL grant that may overlap in a time resource by monitoring SCI from other UEs to avoid half duplex interference.

In various embodiments of the second embodiment, half duplex avoidance may be configured only for high priority traffic and may be configured per logical channel (“LCH”). In certain embodiments of the second embodiment, half duplex avoidance may be needed if a priority-TX of a TX UE transmission is a lower priority than a priority-RX of one or more other UEs (e.g., absolute priority of TX > priority of RX from other UEs). In some embodiments of the second embodiment, a sidelink (“SL”) priority threshold is defined and, if the priority of a TB is above the SL priority threshold, then half duplex avoidance may be performed. In various embodiments of the second embodiment, half duplex avoidance is needed if a SL reference signal received power (“RSRP”) and/or a received signal strength indication (“RSSI”) threshold of RX UEs is above a certain configured threshold. In some embodiments of the second embodiment, half duplex avoidance may be used based on a remaining PDB. In various embodiments of the second embodiment, half duplex avoidance may be used based on a combination of priority and RSRP.

In certain embodiments, a SL grant from a gNB contains a destination ID and a TX UE LCP procedure is not performed. The gNB makes sure that there are not two TX UEs having the same destination ID transmitting in the same time slot.

In a third embodiment, UEs exchange destination IDs. In the third embodiment, in a UE to UE interface (“PC5”) radio resource control (“RRC”) connection, a first UE (UEA) and a second UE (UEB) exchange configured destination ID for a resource exclusion process. In one embodiment of the third embodiment, UEB informs UEA about a list of destination IDs and UEA in its resource exclusion procedure excludes transmission to those destination IDs or a subset of destination IDs for which there is an overlap in a time resource between UEA and UEB.

In certain embodiments of the third embodiment, the TX UE avoids overlaps or triggers resource selection (or reselection) only if more than one consecutive time resource overlaps for transmissions from different UEs to the same destination IDs.

In a fourth embodiment, mode and/or link switching may occur. In the fourth embodiment, a TX UE may switch from mode 2 to mode 1 (e.g., gNB resource allocation) resource allocation based on one of the following: 1) the TX UE receives consecutive NACKs or DTX and therefore the TX UE transmits (or retransmits) a TB using mode 1 resource allocation; and/or a channel busy ratio (“CBR”) measurement report for which the TX UE performs any new transmission of a TB (e.g., if a corresponding logical channel is configured for both model and mode 2) or any remaining blind retransmission of a TB using mode 1 resource allocation.

In various embodiments, a TX UE may switch from PC5 to Uu (e.g., UE to network interface) based on consecutive NACKs, consecutive DTX, and/or a CBR measurement report.

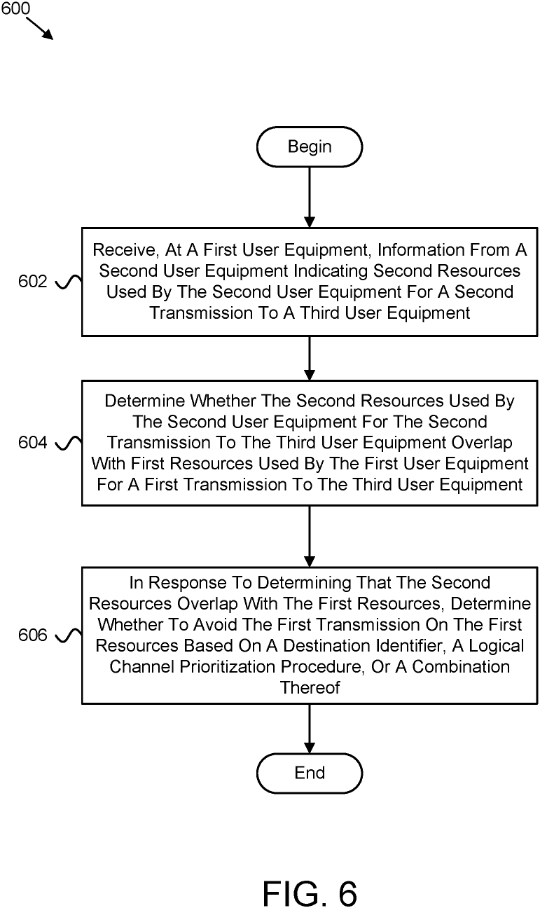

FIG. 6 is a flow chart diagram illustrating one embodiment of a method 600 for determining transmissions to avoid. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602, at a first user equipment, information from a second user equipment indicating second resources used by the second user equipment for a second transmission to a third user equipment. In certain embodiments, the method 600 includes determining 604 whether the second resources used by the second user equipment for the second transmission to the third user equipment overlap with first resources used by the first user equipment for a first transmission to the third user equipment. In certain embodiments, the method 600 includes, in response to determining that the second resources overlap with the first resources, determining 606 whether to avoid the first transmission on the first resources based on a destination identifier, a logical channel prioritization procedure, or a combination thereof.

In certain embodiments, the information from the second user equipment comprises the destination identifier, a reserved resource, a conflicted resource, or some combination thereof. In some embodiments, the first user equipment avoids the first transmission on the first resources in response to the destination identifier indicating the third user equipment. In various embodiments, the first user equipment avoids the first transmission on the first resources in response to a first priority of the first transmission being less than a second priority of the second transmission.

In one embodiment, determining whether to avoid the first transmission on the first resources comprises determining whether to avoid the first transmission on the first resources based on a priority of the first transmission, a priority of the second transmission, a logical channel, a priority of the logical channel, or some combination thereof. In certain embodiments, the logical channel prioritization procedure comprises determining whether the first resources were reserved before the second resources. In some embodiments, the overlap is a result of a time conflict, a frequency conflict, or a combination thereof.

In various embodiments, the first user equipment avoids the first transmission on the first resources to a destination in response to the second resources being reserved before the first resources for the destination. In one embodiment, in response to receiving the information from the second user equipment indicating the second resources used by the second user equipment for the second transmission to the third user equipment prior to a time threshold, the first user equipment avoids the first transmission on the first resources. In certain embodiments, the method 600 further comprises performing resource reselection of third resources for transmission to the third user equipment in response to determining that the second resources overlap with the first resources.

In some embodiments, the method 600 further comprises transmitting information indicating the first resources used by the first user equipment for the first transmission to the third user equipment. In various embodiments, determining whether the second resources used by the second user equipment for the second transmission to the third user equipment overlap with the first resources used by the first user equipment for the first transmission to the third user equipment comprises determining whether more than one consecutive time resource used by the second user equipment for the second transmission to the third user equipment overlaps with more than one consecutive time resource used by the first user equipment for the first transmission to the third user equipment.

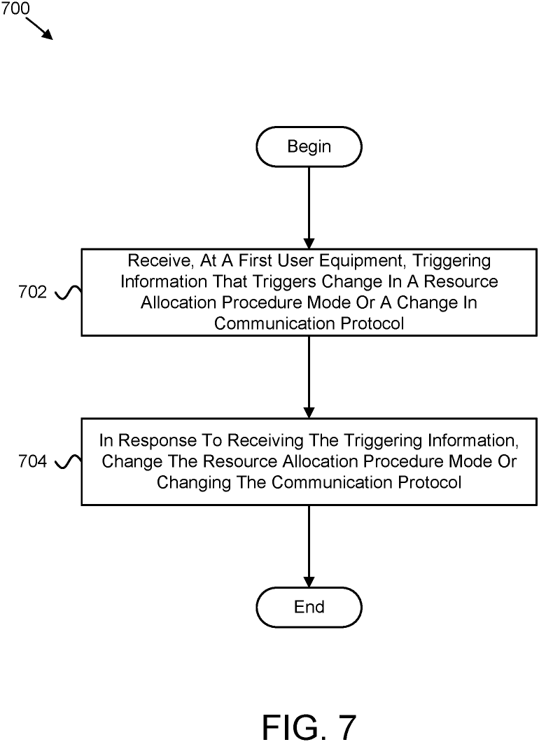

FIG. 7 is a flow chart diagram illustrating one embodiment of a method 700 for triggering a change. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a first user equipment, triggering information that triggers change in a resource allocation procedure mode or a change in communication protocol. In some embodiments, the method 700 includes, in response to receiving the triggering information, changing 704 the resource allocation procedure mode or changing the communication protocol.

In certain embodiments, the triggering information comprises receiving two consecutive negative acknowledgements. In some embodiments, the triggering information comprises receiving a channel busy ratio measurement report. In various embodiments, changing the resource allocation procedure mode comprises changing from a second resource allocation procedure mode to a first resource allocation procedure mode.

In one embodiment, the first resource allocation procedure mode comprises receiving a sidelink grant from a network device. In certain embodiments, changing the communication protocol comprises changing from a user equipment to user equipment communication protocol to a user equipment to network communication protocol.

In one embodiment, a method comprises: receiving, at a first user equipment, information from a second user equipment indicating second resources used by the second user equipment for a second transmission to a third user equipment; determining whether the second resources used by the second user equipment for the second transmission to the third user equipment overlap with first resources used by the first user equipment for a first transmission to the third user equipment; and in response to determining that the second resources overlap with the first resources, determining whether to avoid the first transmission on the first resources based on a destination identifier, a logical channel prioritization procedure, or a combination thereof.

In certain embodiments, the information from the second user equipment comprises the destination identifier, a reserved resource, a conflicted resource, or some combination thereof.

In some embodiments, the first user equipment avoids the first transmission on the first resources in response to the destination identifier indicating the third user equipment.

In various embodiments, the first user equipment avoids the first transmission on the first resources in response to a first priority of the first transmission being less than a second priority of the second transmission.

In one embodiment, determining whether to avoid the first transmission on the first resources comprises determining whether to avoid the first transmission on the first resources based on a priority of the first transmission, a priority of the second transmission, a logical channel, a priority of the logical channel, or some combination thereof.

In certain embodiments, the logical channel prioritization procedure comprises determining whether the first resources were reserved before the second resources.

In some embodiments, the overlap is a result of a time conflict, a frequency conflict, or a combination thereof.

In various embodiments, the first user equipment avoids the first transmission on the first resources to a destination in response to the second resources being reserved before the first resources for the destination.

In one embodiment, in response to receiving the information from the second user equipment indicating the second resources used by the second user equipment for the second transmission to the third user equipment prior to a time threshold, the first user equipment avoids the first transmission on the first resources.

In certain embodiments, the method further comprises performing resource reselection of third resources for transmission to the third user equipment in response to determining that the second resources overlap with the first resources.

In some embodiments, the method further comprises transmitting information indicating the first resources used by the first user equipment for the first transmission to the third user equipment.

In various embodiments, determining whether the second resources used by the second user equipment for the second transmission to the third user equipment overlap with the first resources used by the first user equipment for the first transmission to the third user equipment comprises determining whether more than one consecutive time resource used by the second user equipment for the second transmission to the third user equipment overlaps with more than one consecutive time resource used by the first user equipment for the first transmission to the third user equipment.

In one embodiment, an apparatus comprises a first user equipment, the apparatus further comprises: a receiver that receives information from a second user equipment indicating second resources used by the second user equipment for a second transmission to a third user equipment; and a processor that: determines whether the second resources used by the second user equipment for the second transmission to the third user equipment overlap with first resources used by the first user equipment for a first transmission to the third user equipment; and in response to determining that the second resources overlap with the first resources, determines whether to avoid the first transmission on the first resources based on a destination identifier, a logical channel prioritization procedure, or a combination thereof.

In certain embodiments, the information from the second user equipment comprises the destination identifier, a reserved resource, a conflicted resource, or some combination thereof.

In some embodiments, the first user equipment avoids the first transmission on the first resources in response to the destination identifier indicating the third user equipment.

In various embodiments, the first user equipment avoids the first transmission on the first resources in response to a first priority of the first transmission being less than a second priority of the second transmission.

In one embodiment, the processor determining whether to avoid the first transmission on the first resources comprises the processor determining whether to avoid the first transmission on the first resources based on a priority of the first transmission, a priority of the second transmission, a logical channel, a priority of the logical channel, or some combination thereof.

In certain embodiments, the logical channel prioritization procedure comprises determining whether the first resources were reserved before the second resources.

In some embodiments, the overlap is a result of a time conflict, a frequency conflict, or a combination thereof.

In various embodiments, the first user equipment avoids the first transmission on the first resources to a destination in response to the second resources being reserved before the first resources for the destination.

In one embodiment, in response to receiving the information from the second user equipment indicating the second resources used by the second user equipment for the second transmission to the third user equipment prior to a time threshold, the first user equipment avoids the first transmission on the first resources.

In certain embodiments, the processor performs resource reselection of third resources for transmission to the third user equipment in response to determining that the second resources overlap with the first resources.

In some embodiments, the method further comprises a transmitter that transmits information indicating the first resources used by the first user equipment for the first transmission to the third user equipment.

In various embodiments, the processor determining whether the second resources used by the second user equipment for the second transmission to the third user equipment overlap with the first resources used by the first user equipment for the first transmission to the third user equipment comprises the processor determining whether more than one consecutive time resource used by the second user equipment for the second transmission to the third user equipment overlaps with more than one consecutive time resource used by the first user equipment for the first transmission to the third user equipment.

In one embodiment, a method comprises: receiving, at a first user equipment, triggering information that triggers change in a resource allocation procedure mode or a change in communication protocol; and in response to receiving the triggering information, changing the resource allocation procedure mode or changing the communication protocol.

In certain embodiments, the triggering information comprises receiving two consecutive negative acknowledgements.

In some embodiments, the triggering information comprises receiving a channel busy ratio measurement report.

In various embodiments, changing the resource allocation procedure mode comprises changing from a second resource allocation procedure mode to a first resource allocation procedure mode.

In one embodiment, the first resource allocation procedure mode comprises receiving a sidelink grant from a network device.

In certain embodiments, changing the communication protocol comprises changing from a user equipment to user equipment communication protocol to a user equipment to network communication protocol.

In one embodiment, an apparatus comprises a user equipment, the apparatus further comprises: a receiver that receives triggering information that triggers change in a resource allocation procedure mode or a change in communication protocol; and a processor that, in response to receiving the triggering information, changes the resource allocation procedure mode or changing the communication protocol.

In certain embodiments, the triggering information comprises the receiver receiving two consecutive negative acknowledgements.

In some embodiments, the triggering information comprises the receiver receiving a channel busy ratio measurement report.

In various embodiments, the processor changing the resource allocation procedure mode comprises the processor changing from a second resource allocation procedure mode to a first resource allocation procedure mode.

In one embodiment, the first resource allocation procedure mode comprises the receiver receiving a sidelink grant from a network device.

In certain embodiments, the processor changing the communication protocol comprises the processor changing from a user equipment to user equipment communication protocol to a user equipment to network communication protocol.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
receiving, at a first user equipment, information from a second user equipment indicating second resources used by the second user equipment for a second transmission to a third user equipment;
determining whether the second resources used by the second user equipment for the second transmission to the third user equipment overlap with first resources used by the first user equipment for a first transmission to the third user equipment; and
in response to determining that the second resources overlap with the first resources, determining whether to avoid the first transmission on the first resources based on a destination identifier, a logical channel prioritization procedure, or a combination thereof.

2. The method of claim 1, wherein the information from the second user equipment comprises the destination identifier, a reserved resource, a conflicted resource, or some combination thereof.

3. The method of claim 1, wherein the first user equipment avoids the first transmission on the first resources in response to the destination identifier indicating the third user equipment.

4. The method of claim 1, wherein the first user equipment avoids the first transmission on the first resources in response to a first priority of the first transmission being less than a second priority of the second transmission.

5. The method of claim 1, wherein determining whether to avoid the first transmission on the first resources comprises determining whether to avoid the first transmission on the first resources based on a priority of the first transmission, a priority of the second transmission, a logical channel, a priority of the logical channel, or some combination thereof.

6. The method of claim 1, wherein the logical channel prioritization procedure comprises determining whether the first resources were reserved before the second resources.

7. The method of claim 1, wherein the overlap is a result of a time conflict, a frequency conflict, or a combination thereof.

8. The method of claim 5, wherein the first user equipment avoids the first transmission on the first resources to a destination in response to the second resources being reserved before the first resources for the destination.

9. The method of claim 1, wherein, in response to receiving the information from the second user equipment indicating the second resources used by the second user equipment for the second transmission to the third user equipment prior to a time threshold, the first user equipment avoids the first transmission on the first resources.

10. The method of claim 1, further comprising performing resource reselection of third resources for transmission to the third user equipment in response to determining that the second resources overlap with the first resources.

11. The method of claim 1, further comprising transmitting information indicating the first resources used by the first user equipment for the first transmission to the third user equipment.

12. The method of claim 1, wherein determining whether the second resources used by the second user equipment for the second transmission to the third user equipment overlap with the first resources used by the first user equipment for the first transmission to the third user equipment comprises determining whether more than one consecutive time resource used by the second user equipment for the second transmission to the third user equipment overlaps with more than one consecutive time resource used by the first user equipment for the first transmission to the third user equipment.

13. An apparatus comprising a first user equipment, the apparatus further comprising:
a receiver that receives information from a second user equipment indicating second resources used by the second user equipment for a second transmission to a third user equipment; and
a processor that:
determines whether the second resources used by the second user equipment for the second transmission to the third user equipment overlap with first resources used by the first user equipment for a first transmission to the third user equipment; and
in response to determining that the second resources overlap with the first resources, determines whether to avoid the first transmission on the first resources based on a destination identifier, a logical channel prioritization procedure, or a combination thereof.

14. (canceled)

15. The apparatus of claim 20, wherein the triggering information comprises receiving two consecutive negative acknowledgements.

16. The apparatus of claim 20, wherein the triggering information comprises receiving a channel busy ratio measurement report.

17. The apparatus of claim 20, wherein the processor changing the resource allocation procedure mode comprises the processor changing from a second resource allocation procedure mode to a first resource allocation procedure mode.

18. The apparatus of claim 17, wherein the first resource allocation procedure mode comprises receiving a sidelink grant from a network device.

19. The apparatus of claim 20, wherein the processor changing the communication protocol comprises the processor changing from a user equipment to user equipment communication protocol to a user equipment to network communication protocol.

20. An apparatus comprising a user equipment, the apparatus further comprising:
a receiver that receives triggering information that triggers change in a resource allocation procedure mode or a change in communication protocol; and
a processor that, in response to receiving the triggering information, changes the resource allocation procedure mode or changing the communication protocol.

21. The apparatus of claim 13, wherein the information from the second user equipment comprises the destination identifier, a reserved resource, a conflicted resource, or some combination thereof.
